(19) United States
(12) Patent Application Publication
(10) Pub. No.: US 2007/0088874 A1
(43) Pub. Date: Apr. 19, 2007

(54) Offload engine as processor peripheral

(75) Inventor: Richard Brabant, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/249,380

(22) Filed: Oct. 14, 2005

(51) Int. Cl. G06F 13/38

(52) U.S. Cl. 710/62

(57) ABSTRACT

A system for interfacing a processor with a peripheral component. The system includes a module interface connected with the processor, a peripheral interface unit connected between the module interface and a peripheral component connected to the peripheral interface unit. The peripheral interface unit includes a peripheral interface to communicate with a peripheral component, a mailbox storage unit to store data defining communication between the module interface and the peripheral interface, and an interface state machine to communicate data between the mailbox storage unit and the peripheral interface responsive to commands received from the module interface and the peripheral interface.

### FIELD

The disclosed embodiments relate to an offload engine for a processor to communicate with a peripheral component.

### BACKGROUND

Communication between a processor and peripheral components located on the same circuit board may be accomplished using an inter-integrated circuit (I2C) bus protocol. In comparison to higher speed memory communication, the I2C protocol supports communication with slow, on-circuit-board peripheral components. Access of the I2C-based components typically occurs intermittently and requires lesser hardware resources. I2C is understood to be a simple, low-bandwidth, short-distance protocol.

Many I2C-based devices operate at speeds up to 400 Kbps. I2C relatively easily links a processor and multiple peripheral components together using a built-in addressing system.

An example I2C use includes a processor, e.g., a general purpose or application specific integrated circuit (ASIC), a custom ASIC, an embedded processor, using I2C to communicate with external components. The processor interacts with the external components using the I2C protocol over a two-wire serial bus. By not requiring addressing or bus arbitration logic, the processor manages the protocol interactions with the components. Often, because of a disparity between the processor operating rate and the relatively slow I2C protocol and components, processor control of the I2C communication is cumbersome, i.e., a large amount of overhead in terms of context switches and setup time is required by the processor. That is, the processor is required to perform a large amount of overhead processing for a low data rate transaction.

Another prior approach included the use of an external UART combined with a microcontroller for interfacing with an I2C component; however, the added UART device adds cost and requires implementation-specific software for the particular application increasing cost, complexity, and maintenance.

The I2C protocol uses a serial data (SDA) signal and a serial clock (SCLK) signal to support serial transmission of 8-bit bytes of data along with device address bits and control bits over a two-wire serial bus. According to the protocol, a master device initiates a transaction on the I2C bus and normally controls the clock signal. A slave is addressed by the master device.

In operation, a master device begins communication with the slave by issuing a start condition. The master sends a slave address over the I2C bus. A read/not-write bit transmitted after the start condition, specifies whether the slave receives or transmits data. An ACK bit issued by the receiver, acknowledges receipt of the previous byte. The transmitter (slave or master, as dictated by the bit) transmits a byte of data to the addressed receiver. After receipt of the transmitted byte, the receiver issues another ACK bit. The pattern of transmission/receipt is repeated for additional bytes transmitted.

If a slave is to perform a write transaction, when the master completes transmission of all the data bytes needed to be sent, the master monitors the last ACK and issues a stop condition. If a slave is to perform a read transaction, i.e., provide data to a master, an acknowledgement from the master is received as long as it is not the last read byte. On the last read byte the master does not issue the ACK, instead the master then issues a stop condition.

### SUMMARY

The present embodiments provide an offload engine for a processor to communicate with a peripheral component.

A system embodiment for interfacing a processor having a first bus with a peripheral component includes a module interface configured to connect with a first processor bus at a first data rate and a peripheral interface unit configured to connect between the module interface and a peripheral component connectable to the peripheral interface unit by a second bus at a second data rate. The peripheral interface unit includes a peripheral interface configured to communicate with a peripheral component, a mailbox storage unit configured to store data in one or more registers for communication between the module interface and the peripheral interface, and an interface state machine configured to communicate data between the mailbox storage unit and the peripheral interface responsive to commands received from at least one of the module interface and the peripheral interface.

A method embodiment of interfacing a processor having a first bus with a peripheral component, where the processor includes a peripheral interface unit connected with a first bus of the processor and connectable with the peripheral component, and where the peripheral interface unit includes a mailbox storage unit, a peripheral interface connectable with the peripheral component, and an interface state machine connected between the first bus and the peripheral interface, includes generating, by the interface state machine, a series of first data signals responsive to receipt by the peripheral interface unit of a communication from the processor; generating, by the peripheral interface unit, a series of second data signals for communication to the peripheral component responsive to receipt of the series of data signals; generating, by the peripheral interface unit, one or more second response signals for communication to the interface state machine, responsive to receipt by the peripheral interface unit of one or more first response signals from the peripheral component responsive to one or more of the generated series of data signals; and generating, by the interface state machine, one or more third response signals for communication on the first bus using the mailbox storage unit responsive to receipt of the one or more second response signals from the peripheral interface unit.

Still other advantages of the embodiments will become readily apparent to those skilled in the art from the following detailed description, wherein the preferred embodiments are shown and described, simply by way of illustration of the best mode contemplated of carrying out the invention. As will be realized, the invention is capable of other and different embodiments, and its several details are capable of modifications in various obvious respects, all without departing from the embodiments.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of an embodiment;

FIG. 2 is a high level block diagram according to another embodiment; and

FIG. 3 is a high level block diagram of detail of the mailbox storage unit of the FIG. 1 embodiment.

### DETAILED DESCRIPTION

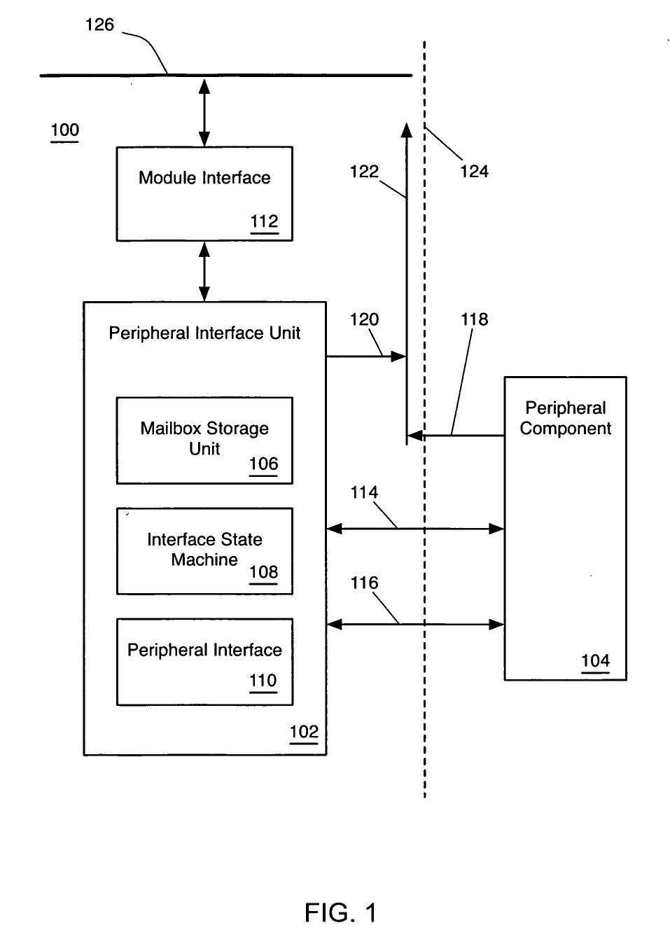

FIG. 1 depicts a portion of a processor 100, e.g., an embedded processor of a networking device, including a peripheral interface unit 102 connected to an I2C-based peripheral component 104. Dashed line 124 denotes the separation between processor 100 and external components connected to the processor. Communication between processor 100 and peripheral interface unit 102 occurs using a bus 126, e.g., an advanced high performance processor bus, connecting the processor and a module interface 112 which in turn is connected to the peripheral interface unit. Communication between peripheral component 104 and peripheral interface unit 102 occurs using an I2C communication protocol.

Peripheral interface unit 102 includes a mailbox storage unit 106, an interface state machine 108, and a peripheral interface 110. Each component of peripheral interface unit 102 is now described in further detail.

Peripheral interface unit 102 communicates with peripheral component 104 using a two line I2C bus made up of a data line 114 and a clock line 116.

Peripheral interface unit 102 and peripheral component 104 each include an interrupt line, i.e., component interrupt line 118 and interface unit interrupt line 120, connected to an interrupt mechanism 122, e.g., an interrupt bus, connected to an interrupt handling portion of processor 100 (not shown).

Mailbox storage unit 106 includes a set of registers shared by processor 100 (by way of a module interface 112) and interface state machine 108. The register set stores control signals, data exchanged in both directions between processor 100 and peripheral component 104, and reporting errors from peripheral interface 110. There are as many mailbox storage units 106 as there are peripheral interfaces 110. For each I2C bus, pairing of data line 114 and clock line 116, there is a peripheral interface unit 102. There may be more than one peripheral components connected to the I2C bus.

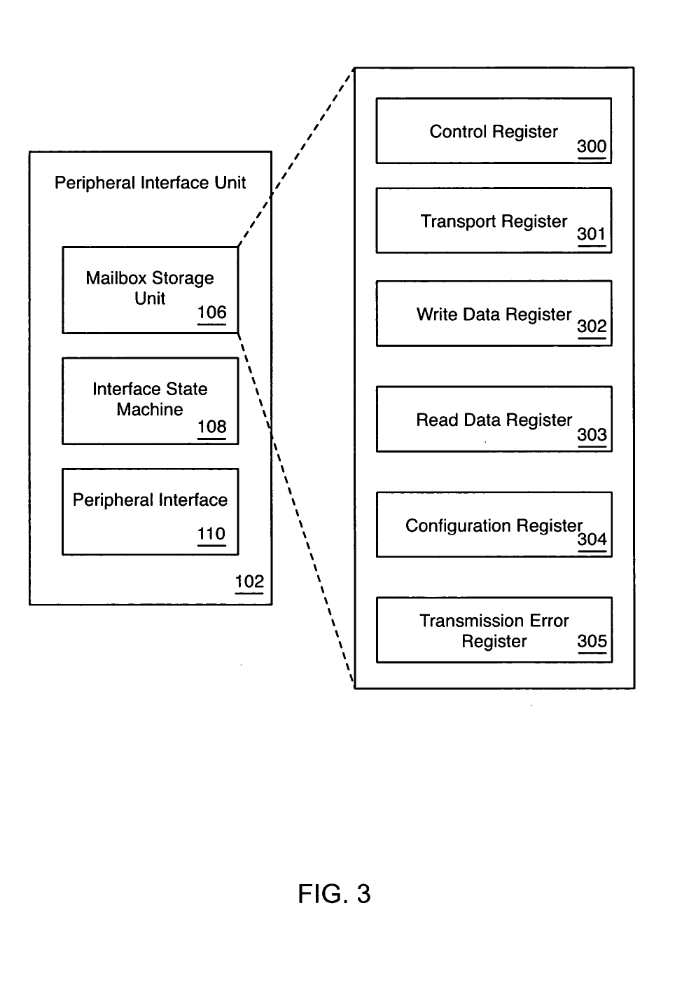

As depicted in FIG. 3, mailbox storage unit 106 register set includes a control register 300, a transport register 301, a write data register 302, a read data register 303, a configuration register 304, and a transaction error register 305.

Peripheral interface 110 includes a logic core library for communicating over an I2C bus, one such peripheral interface is available from Mentor Graphics of Wilsonville, Oreg. and having a datasheet reference number 04/02 PS-40135.001-FC.

Interface state machine 108 communicates with peripheral interface 110, based on the contents of mailbox storage unit 106 registers, in order to transfer data between processor 100 and peripheral component 104. Interface state machine 108 also reports back to, e.g., stores in, mailbox storage unit 106 registers, the read data, the status data and eventually the errors, if any occurred during the time the peripheral interface 110 is in communication with peripheral component 104 through the I2C bus.

Processor 100 either stores data in mailbox storage unit 106 by addressing an appropriate read/write command and data, as appropriate, to peripheral interface unit 102 by way of module interface 112 in the case of preparing a future launch of an access to the peripheral component 104 or processor 100 reads from mailbox storage unit 106 the status data and the data returned by access of peripheral component 104.

In operation, processor 100 prepares data or configuration data for future execution as a transaction with the peripheral component prior to raising the launch flag. The last action performed by processor 100 is to cause the launch flag to be set to true. In an embodiment, the launch flag is a single bit of the control register 300 and is set by processor 100 writing to a register in mailbox storage unit 106 by way of module interface 112. After detecting the raised launch flag, interface state machine 108 reads the prepared data and/or configuration data from mailbox storage unit 106 and executes the desired actions, change of internal configuration or controls or launches any I2C transactions. After completion of the transaction by interface state machine 108, e.g., data retrieved from a peripheral component 104 is stored in a mailbox storage unit 106 register, the last action of the interface state machine is to clear the launch flag, i.e., set the launch flag to false.

Peripheral interface unit 102 is defined for complying with a processor 100 polling status data in a timed manner or interrupted on a I2C transaction completion. For example, a mailbox interrupt is set to true whenever interface state machine 108 clears the launch flag signal stored in control register 300 (FIG. 3). The mailbox interrupt may be cleared by processor 100 on either a read or write to a special alias control register 300 address. The same physical register, i.e., control register 300 and transport register 301, is accessible under two different addresses: control register and control register alias (depicted in Table 1 below) and transport register and transport register alias (depicted in Table 1 below). Access to control register address 300 does not clear the interrupt set on interrupt bus 122 whereas access to the second address, i.e., the alias, clears the interrupt. Similarly, access to transport register address 301 does not clear the interrupt whereas access to control register alias clears the interrupt. The two different addresses allow processor 100 to communicate signals to peripheral interface unit 102 to select which appropriate access mechanism to operate in terms of the desired clear or not clear of the interrupt that is required. Processor 100 is able to choose whether or not to clear a received interrupt and clear the interrupt by utilization of either an address or an alias address, as appropriate. Processor 100 uses the second addresses, i.e., aliases, to clear the interrupt set by the peripheral interface unit 102 on completion. In this manner, in an embodiment, processor 100 is able to store data (write) or either to fetch data (read) from mailbox storage unit 106 registers and clear the interrupt in a single transaction. This signaling behavior supports both solutions, polling status data on a timely manner or responding based on a generated interrupt.

Peripheral interface unit 102 also supports a “transparent” mode giving direct communication through the native protocol of peripheral interface 110, e.g., Mentor IP (MI2C), and is mainly intended to be a debug tool used during firmware and hardware development.

Table 1 below identifies the usage of different registers of mailbox storage unit 106 according to the mode of peripheral interface unit 102.

TABLE 1

Mode

| normal | transparent | Register Name |
|---|---|---|
| v | — | control register 300 |
| — | v | transport register 301 |
| v | v | write data register 302 |
| v | v | read data register 303 |
| v | — | configuration register 304 |
| v | — | transaction error register 305 |
| v | — | control register alias |
| — | v | transport register alias |

A “v” in a column indicates use whereas a “-” indicated non-use. In transparent mode, only byte 0 is used in connection with the write data register 302 and read data register 303.

In the normal mode of operation, each of the peripheral interface units 102 sets a respective mailbox interrupt to processor 100 after completion of the requested I2C transaction. The mailbox interrupt is set in addition to clearing the launch flag signal.

In the transparent mode of operation, a read and write to transport register 301 and corresponding transport register alias clears the mailbox interrupt.

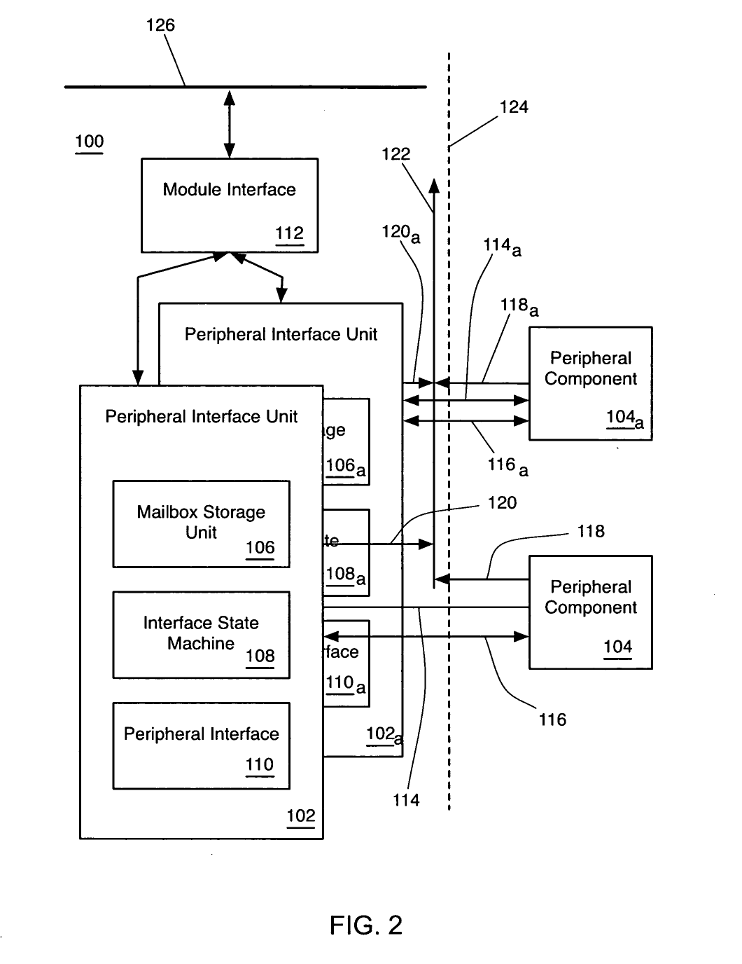

FIG. 2 depicts an embodiment in which more than one I2C bus is used in the application. Each individual I2C bus operates independently and may have its own multiple peripheral components. Each individual I2C bus is electrically isolated from the other bus and there is no interference between busses. Multiple independent I2C busses may be of any number and are not limited to two as in the depicted example. Module interface 112 includes decoding functionality for determining with which peripheral interface unit 102 processor 100 is in communication.

Control Register 300 Values

During communication between peripheral interface unit 102 and processor 100 in order to effect an I2C transaction, the following information is transferred via storing of values in control register 300:

a. Launch flag, not I2C transaction completed.

b. Error condition encountered.

c. Start, on I2C start the first byte transmitted is an address byte defined in the control register.

d. Stop, end of an I2C transaction.

e. Continue, incremental access to an I2C-based device, without driving a “start”. The continue bit is the only control bit that anticipates on what will be processed on the following launched command.

f. Number of bytes (values: 0; 1; 2; 3; 4) of data taking place in this command. Little endian and 4 bytes at the most or a word of 32 bits at a time.

g. Stop_start_combo, Start on I2C bus is preceded by a stop.

h. Frequency div, Update or change the I2C bus frequency divider.

i. Update the control register of mailbox storage unit 106 of peripheral interface unit 102.

j. Transparent_mode in which step by step processor 100 controls peripheral interface 110; intended to be used in debug mode.

k. I2C address bits of a Start.

l. Read-not write bit defined the transaction on the I2C bus, read access not write control.

Each of the above information is now described in further detail.

Launch Flag

After processor 100 causes the launch flag to be set to true, an I2C transaction is started based on the definition of the requested transaction stored in the appropriate mailbox storage unit 106 registers. During the time period of the launch flag not being cleared by peripheral interface unit 102 at the completion of the transaction, the peripheral interface unit continues to process the requested transaction under the supervision of interface state machine 108. During this time period, the control data stored in the mailbox storage unit 106 registers 300-305 remains unchanged until the requested transaction completes.

On completion of the requested transaction, e.g., end of a given sequence, termination of a transaction, or error generation, etc., interface state machine 108 sets the launch flag to false, thereby clearing the launch flag. On encountering an error, interface state machine 108 reports the error before clearing the launch flag and ends by returning to an idle state waiting for commands.

Error Condition

There are three different categories of errors: I2C handshake “ACK” failure, I2C bus error, and unknown or conflicting set of command passed to the peripheral interface unit. Transaction error register 305 stores detailed information if the error signal is set to true.

Start

If a start signal is set true, the requested I2C transaction begins by transmission of an I2C START command followed by the byte of the address defined in the control register. The start signal is also used for transmitting an I2C repeated START command. If the stop_start_combo signal is true (described below), the I2C START may be preceded by a STOP command.

Stop

If a stop signal is set true, the requested I2C transaction ends by transmitting an I2C STOP command.

Continue

If a continue signal is set true, the requested I2C transaction is part of a series of sequential I2C transactions continuing in the subsequent request. The continue signal is a lower priority than the start and stop signals allowing peripheral interface unit 102 to ignore the state of the continue signal if a requested transaction includes a start true and a stop true.

Number of Bytes

The number of bytes specifies the number of bytes of data read or written on the I2C bus for a given sequence of I2C transactions currently set in mailbox storage unit 106 registers.

Stop_start_combo

If a stop start combo signal is set true, the I2C START command is preceded by an I2C STOP command. The stop_start_combo signal allows a new I2C transaction to begin after occurrence of an error as on an error interface state machine 108 reports the error and returns to an idle state without execution of an I2C STOP command on the I2C bus.

Frequency Div

If a frequency div signal is set true, a portion of the contents of the configuration register 304 setting a target frequency for the I2C bus is loaded into peripheral interface 110. Interface state machine 108 writes the frequency into peripheral interface 110 after the launch flag is set. If the frequency div signal is received along with an I2C transaction request, the frequency is written prior to execution of the requested transaction.

Update Control Register

If an update control signal is set true, interface state machine 108 stores a portion of the contents of configuration register 304 in a control register in peripheral interface 110. Similar to the frequency div signal, interface state machine 108 writes the portion of the contents of configuration register 304 into peripheral interface 110 after the launch flag is. set. If the update control signal is received along with an I2C transaction request, the configuration register contents is written prior to execution of the requested transaction.

Transparent Mode

If a transparent mode signal is set true, processor 100 controls peripheral interface 110. If the transparent mode signal is set false, peripheral interface unit 102 operates in a normal mode responsive to processor 100.

I2C Address Bits

The I2C address bits signal provide the I2C address bits for the current requested transaction in normal mode of operation of peripheral interface unit 102.

Read-Not Write

The read-not write signal is the I2C read not write signal or part of the address bit of the current requested transaction in normal mode of operation of peripheral interface unit 102.

### EXAMPLES

Transaction examples are provided in the following tables describing control register 300 setup, actions, and whether processor 100 or peripheral interface unit 102 is in control of execution of the command. Processor 100 initiates commands by writing the appropriate values to the registers in mailbox storage unit 106 by way of module interface 112. That is, processor 100 addresses a read or write to the address of module interface 112 and the module interface maps the read or write to the appropriate registers of mailbox storage unit 106.

Interface state machine 108 interprets the control signals received from processor 100 and reads and writes data to/from registers in mailbox storage unit 106. Interface state machine 108 also controls peripheral interface 110 to control the I2C bus as a master. Interface state machine also signals completion of an I2C transaction.

“One Shot” No Error

According to the example of Table 2 (listing actions in time order with time advancing down the page), peripheral interface unit 102 completes an entire I2C transaction by initiating a START command on the I2C bus, performing read or write access of peripheral component 104, i.e., an I2C-based device connected at the other end of the I2C bus, and terminates the transaction by issuing a STOP command on the I2C bus. Processor 100 detects completion of the requested I2C transaction by either polling the launch flag status or enabling the mailbox interrupt.

TABLE 2

| launch_flag | start | stop | continue | Description of actions | In control |
|---|---|---|---|---|---|
| 0 | X | X | X | Write data if performing an I2C write | processor |
| 1 | 1 | 1 | X | Launch a single I2C access, up to 4 bytes of data. | processor |
| | | | | Write the appropriate control bits and data to control | |
| | | | | register 300 | |
| 1 | 1 | 1 | X | Initiate START I2C. | PIU |
| 1 | 1 | 1 | X | Check returned IP status = START done (if not error). | PIU |
| 1 | 1 | 1 | X | Initiate send I2C address + read/not write (rnw) signal. | PIU |
| 1 | 1 | 1 | X | Check returned IP status = (write) done (if not error); | PIU |
| | | | | IP status = (read) done (if not error). | |
| 1 | 1 | 1 | X | Initiate 1st byte read or write. | PIU |
| 1 | 1 | 1 | X | Check returned IP status = (write) done (if not error); | PIU |
| | | | | IP status = (read) done (if not error). | |
| | | | | If read, write read data in read data register 303. | |

IF there is more byte(s) to process:

| | | | | | |
|---|---|---|---|---|---|
| 1 | 1 | 1 | X | Initiate 2nd byte read or write. | PIU |
| 1 | 1 | 1 | X | Check returned IP status = (write) done (if not error); | PIU |
| | | | | IP status = (read) done (if not error). | |
| | | | | If read, write read data in read data register 303. | |

repeat above until the 4th byte.

| | | | | | |
|---|---|---|---|---|---|
| 1 | 1 | 1 | X | Initiate a STOP I2C. | PIU |
| 0 | X | X | X | Clear status. | PIU |
| | | | | If read, data available in read data register 303. | |
| | | | | Then ready to launch a new I2C access. | |

In Table 2, PIU refers to peripheral interface unit 102 and processor refers to processor 100. The columns designated launch_flag, start, stop, and continue represent bit values stored in control register 300 of mailbox storage unit 106 according to an embodiment. An X in a column indicates that the particular value is not relevant to the action being performed.

“Continued Transaction” Incremental Only, No Error

According to the example of Table 3, processor 100 detects completion of a pending I2C transaction access by either polling of the launch flag or enabling the mailbox interrupt.

TABLE 3

| launch_flag | start | stop | continue | Description of actions | In control |
|---|---|---|---|---|---|
| 0 | X | X | X | Write the write data if performing an I2C write | processor |
| 1 | 1 | 0 | 1 | Launch the 1st transaction of a continued I2C access. | processor |
| | | | | Write the appropriate controls and data to control register 300 | |
| 1 | 1 | 0 | 1 | Initiate START I2C. Beginning 1st transaction of a continue. | PIU |
| 1 | 1 | 0 | 1 | Check returned IP status = START done (if not error). | PIU |
| 1 | 1 | 0 | 1 | Initiate send I2C address + rnw. | PIU |
| 1 | 1 | 0 | 1 | Check returned IP status = (write) done (if not error); | PIU |
| | | | | IP status = (read) done (if not error). | |
| 1 | 1 | 0 | 1 | Initiate 1st byte read or write. Data 1st transaction of a | PIU |
| | | | | continue. | |
| 1 | 1 | 0 | 1 | Check returned IP status - (write) done (if not error); | PIU |
| | | | | IP status = (read) done (if not error). | |
| | | | | If read, write read data in read data register 303. | |

----(a) ----> IF there is(are) more byte(s) to process:

| | | | | | |
|---|---|---|---|---|---|
| 1 | 1 | 0 | 1 | Initiate 2nd byte read or write. | PIU |
| 1 | 1 | 0 | 1 | Check returned IP status = (write) done (if not error); | PIU |
| | | | | IP status = (read) done (if not error). | |
| | | | | If read, write read data in read data register 303. | |

----(a) ----> repeat above until the 4th byte.

| | | | | | |
|---|---|---|---|---|---|
| 0 | X | X | X | Clear status. | PIU |
| | | | | If read, data available. | |
| | | | | Then ready to launch a new I2C access. | |

--(c) -->

| | | | | | |
|---|---|---|---|---|---|
| 0 | X | X | X | Write the next continued in write data register 302 if | processor |
| | | | | performing an I2C write. | |
| 1 | 0 | 0 | 1 | Launch the non stop transaction of a continued I2C access. | processor |
| | | | | Write the appropriate controls and data to control register 300. | |
| 1 | 0 | 0 | 1 | Initiate 1st byte read or write. Data 2nd; 3rd . . . trans. of a | processor |
| | | | | continue. | |
| 1 | 0 | 0 | 1 | Check returned IP status = (write) done (if not error); | PIU |
| | | | | IP status = (read) done (if not error). | |
| | | | | If read, write read data in read data register 303. | |

----(b)----> IF ther is(are) more byte(s) to process:

| | | | | | |
|---|---|---|---|---|---|
| 1 | 0 | 0 | 1 | Initiate 2nd byte read or write | PIU |
| 1 | 0 | 0 | 1 | Check returned IP status = (write) done (if not error); | PIU |
| | | | | IP status = (read) done (if not error). | |
| | | | | If read, write read data in read data register 303. | |

----(b)----> repeat above at most until the 4th byte:

| | | | | | |
|---|---|---|---|---|---|
| 0 | X | X | X | Clear status. | PIU |
| | | | | If read, data available in read data register 303. | |
| | | | | Then ready to launch a new I2C access. | |

--(c)--> IF there is(are) more continue transaction(s) without stop needed, repeat “--(c)--> ”loop.

| | | | | | |
|---|---|---|---|---|---|
| 0 | X | X | X | Write the next continued write data register 302 if performing | processor |
| | | | | an I2C write. | |
| 1 | 0 | 1 | X | Launch the stop transaction of a continued I2C access. | processor |
| | | | | Write the appropriate controls and data to control register 300. | |
| 1 | 0 | 1 | X | Initiate 1st byte read or write. Data last transaction of a | PIU |
| | | | | continue. | |
| 1 | 0 | 1 | X | Check returned IP status = (write) done (if not error); | PIU |
| | | | | IP status = (read) done (if not error). | |
| | | | | If read, write read data in read data register 303. | |

--(d)--> IF there is(are) more byte(s) to process:

| | | | | | |
|---|---|---|---|---|---|
| 1 | 0 | 1 | X | Initiate 2nd byte read or write. | PIU |
| 1 | 0 | 1 | X | Check returned IP status = (write) done (if not error); | PIU |
| | | | | IP status = (read) done (if not error). | |
| | | | | If read, write read data in read data register 303. | |

----(d)---->repeat above at most until the 4th byte.

| | | | | | |
|---|---|---|---|---|---|
| 1 | 0 | 1 | X | Initiate a STOP I2C | PIU |
| 0 | X | X | X | Clear status. | PIU |
| | | | | If read, data available in read data register 303. | |
| | | | | Then ready to launch a new I2C access. | |

In Table 3, PIU refers to peripheral interface unit 102 and processor refers to processor 100. The columns designated launch_flag, start, stop, and continue represent bit values stored in control register 300 of mailbox storage unit 106 according to an embodiment. An X in a column indicates that the particular value is not relevant to the action being performed.

“Continued Transaction” Repeat Start, No Error

According to the example of Table 4, a continued transaction over the I2C bus is performed by peripheral interface unit 102. Processor 100 detects completion of a pending I2C transaction access by either polling of the launch flag or enabling the mailbox interrupt.

TABLE 4

| | | | | | |
|---|---|---|---|---|---|
| launch fl | start | stop | continue | Description of actions | In control |

-(f) ->

| | | | | | |
|---|---|---|---|---|---|
| 0 | X | X | X | Write the write data register 302 if performing an I2C write | processor |
| 1 | 1 | 0 | 1 | Launch the 1st transaction of a continued I2C access. | processor |
| | | | | Write the appropriate controls and data to control register 300 | |
| 1 | 1 | 0 | 1 | Initiate START I2C. Beginning 1st transaction of a repeat | PIU |
| | | | | start. | |
| 1 | 1 | 0 | 1 | Check returned IP status = START done (if not error). | PIU |
| 1 | 1 | 0 | 1 | Initiate send I2C address + rnw. | PIU |
| 1 | 1 | 0 | 1 | Check returned IP status = 8′h18 (write) done (if not error); | PIU |
| | | | | IP status = (read) done (if not error). | |
| 1 | 1 | 0 | 1 | Initiate 1st byte read or write. Data 1st transaction of a | PIU |
| | | | | continue. | |

----(a) ----> IF there is(are) more byte(s) to process:

| | | | | | |
|---|---|---|---|---|---|
| 1 | 1 | 0 | 1 | Initiate 2nd byte read or write. | PIU |
| 1 | 1 | 0 | 1 | Check returned IP status = (write) done (if not error); | PIU |
| | | | | IP status = (read) done (if not error). | |
| | | | | If read, write read data in read data register 303. | |

----(a) ----> repeat above at most until the 4th byte.

| | | | | | |
|---|---|---|---|---|---|
| 0 | X | X | X | Clear status. | PIU |
| | | | | If read, data available in read data register 303. | |
| | | | | Then ready to launch a new I2C access. | |

--(c) -->

| | | | | | |
|---|---|---|---|---|---|
| 0 | X | X | X | Write the next continued write data register 302 if performing | processor |
| | | | | an I2C write. | |
| 1 | 0 | 0 | 1 | Launch the non stop transaction of a continued I2C access. | processor |
| | | | | Write the appropriate controls and data to control register 300. | |
| 1 | 0 | 0 | 1 | Initiate 1st byte read or write. Data 2nd; 3rd . . . trans. of a | processor |
| | | | | continue. | |
| 1 | 0 | 0 | 1 | Check returned IP status = (write) done (if not error); | PIU |
| | | | | IP status = (read) done (if not error). | |
| | | | | If read, write read data in read data register 303. | |

----(b)----> IF ther is(are) more byte(s) to process:

| | | | | | |
|---|---|---|---|---|---|
| 1 | 0 | 0 | 1 | Initiate 2nd byte read or write | PIU |
| 1 | 0 | 0 | 1 | Check returned IP status = (write) done (if not error); | PIU |
| | | | | IP status = (read) done (if not error). | |
| | | | | If read, write read data in read data register 303. | |

----(b)----> repeat above at most until the 4th byte:

| | | | | | |
|---|---|---|---|---|---|
| 0 | X | X | X | Clear status. | PIU |
| | | | | If read, data available in read data register 303. | |
| | | | | Then ready to launch a new I2C access. | |

--(c)--> IF there is(are) more continue transaction(s) without repeat start, repeat “--(c)->” loop.

| | | | | | |
|---|---|---|---|---|---|
| 0 | X | X | X | Write the next continued write data register 302 if performing | processor |
| | | | | an I2C write. | |
| 1 | 0 | 0 | 0 | Launch the last transaction of a continued I2C access. Write the | processor |
| | | | | appropriate controls and data to control register 300. | |
| 1 | 0 | 0 | 0 | Initiate 1st byte read or write. Data last transaction of a | PIU |
| | | | | continue. | |
| 1 | 0 | 0 | 0 | Check returned IP status = (write) done (if not error); | PIU |
| | | | | IP status = (read) done (if not error). | |
| | | | | If read, write read data in read data register 303. | |

--(d)--> IF there is(are) more byte(s) to process:

| | | | | | |
|---|---|---|---|---|---|
| 1 | 0 | 0 | 0 | Initiate 2nd byte read or write. | PIU |
| 1 | 0 | 0 | 0 | Check returned IP status = (write) done (if not error); | PIU |
| | | | | IP status = (read) done (if not error). | |
| | | | | If read, write read data in read data register 303. | |

----(d)---->repeat above at most until the 4th byte.

| | | | | | |
|---|---|---|---|---|---|
| 0 | X | X | X | Clear status. If read, data available in read data register 303. | PIU |
| | | | | Then ready to launch a repeat start I2C access. | |

--(f)-->IF more repeat starts needed loop back to the top of the “-(f) -> loop.
Then read: Initiate START I2C. Beginning 1st transaction of a (n)th repeat start

| | | | | | |
|---|---|---|---|---|---|
| 0 | X | X | X | Write the next continued write data register 302 if performing | processor |
| | | | | an I2C write. | |
| 1 | 0 | 1 | X | Launch the stop transaction of a continued I2C access. Write | processor |
| | | | | the appropriate controls and data to control register 300. | |
| 1 | 0 | 1 | X | Initiate 1st byte read or write. Data last transaction of a | PIU |
| | | | | continue. | |
| 1 | 0 | 1 | X | Check returned IP status = (write) done (if not error); | PIU |
| | | | | IP status = (read) done (if not error). | |
| | | | | If read, write read data in read data register 303. | |

--(g)-->IF there is(are) more byte(s) to process:

| | | | | | |
|---|---|---|---|---|---|
| 1 | 0 | 1 | X | Initiate 2nd byte read or write. | PIU |
| 1 | 0 | 1 | X | Check returned IP status = (write) done (if not error); | PIU |
| | | | | IP status = (read) done (if not error). | |
| | | | | If read, write read data in read data register 303. | |

----(g)---->repeat above at most until the 4th byte.

| | | | | | |
|---|---|---|---|---|---|
| 1 | 0 | 1 | X | Initiate a STOP I2C | PIU |
| 0 | X | X | X | Clear status. | PIU |
| | | | | If read, data available in read data register 303. | |
| | | | | Then ready to launch a new I2C access. | |

In Table 4, PIU refers to peripheral interface unit 102 and processor refers to processor 100. The columns designated launch_flag, start, stop, and continue represent bit values stored in control register 300 of mailbox storage unit 106 according to an embodiment. An X in a column indicates that the particular value is not relevant to the action being performed.

Transactions with an Error

In normal operating mode, interface state machine 108 checks the returned status from peripheral interface 110 and compares the status against an expected value. If the status value does not match, an error flag is set and an error code stored in a register in mailbox storage unit 106.

Interface state machine 108 sets an error value in control register 300 if the execution of peripheral interface 110 encounters an unexpected returned status. As a result of receiving an unexpected return status, interface state machine 108 writes a status value into transaction error register 305. Processor 100 is able to read the written value from transaction error register 305 and analyze the error. After an error occurrence, interface state machine 108 clears the launch flag and returns to the idle state. “One Shot” Transaction Error

According to the example of Table 5, processor 100 requests a write of data over the I2C bus and an error is encountered.

TABLE 5

| launch_flag | start | stop | continue | Description of actions | In control |
|---|---|---|---|---|---|
| 0 | X | X | X | Write the write data register 302 if performing an I2C write | processor |
| 1 | 1 | 1 | X | Launch a single I2C access, up to 4 bytes max. of data. | processor |
| | | | | Write the appropriate controls and data to control register 300 | |
| 1 | 1 | 1 | X | Initiate START I2C. | PIU |
| 1 | 1 | 1 | X | Check returned IP status = START done (if not error). | PIU |
| 1 | 1 | 1 | X | Initiate send I2C address + rnw. | PIU |
| 1 | 1 | 1 | X | Check returned IP status = (write) done (if not error); | PIU |
| | | | | IP status = (read) done (if not error). | |
| 1 | 1 | 1 | X | Initiate 1st byte read or write. | PIU |
| 1 | 1 | 1 | X | Check returned IP status = (write) done (if not error); | PIU |
| | | | | IP status = (read) done (if not error). | |
| | | | | If read, write read data in read data register 303. | |

If there are more byte(s) to process:

| | | | | | |
|---|---|---|---|---|---|
| 1 | 1 | 1 | X | Initiate 2nd byte read or write. | PIU |
| 1 | 1 | 1 | X | Check returned IP status = (write) done (if not error); | PIU |
| | | | | IP status = (read) done (if not error). | |
| | | | | If read, write read data in read data register 303. | |

repeat above until the 4th byte.

| | | | | | |
|---|---|---|---|---|---|
| 1 | 1 | 1 | X | Initiate a STOP I2C. | PIU |
| 0 | X | X | X | Clear status. If read, data available in read data register 303. | PIU |
| | | | | Then ready to launch a new I2C access. | |

In Table 5, PIU refers to peripheral interface unit 102 and processor refers to processor 100. The columns designated launch_flag, start, stop, and continue represent bit values stored in control register 300 of mailbox storage unit 106 according to an embodiment. An X in a column indicates that the particular value is not relevant to the action being performed.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A system for interfacing a processor with a peripheral component, comprising:
a module interface configured to connect with a first processor bus at a first data rate; and
a peripheral interface unit configured to connect between the module interface and a peripheral component connectable to the peripheral interface unit by a second bus at a second data rate, the peripheral interface unit comprising:
a peripheral interface configured to communicate with a peripheral component using the second bus;
a mailbox storage unit configured to store data in one or more registers for communication between the module interface and the peripheral interface; and
an interface state machine configured to communicate data between the mailbox storage unit and the peripheral interface responsive to commands received from at least one of the module interface and the peripheral interface.

2. A system as claimed in claim 1, wherein the second bus is an inter-integrated circuit bus and the peripheral interface communicates with the peripheral component using an inter-integrated circuit communication protocol.

3. A system as claimed in claim 1, wherein the interface state machine is configured to cause the mailbox storage unit to store data received from at least one of the peripheral interface and the module interface.

4. A system as claimed in claim 1, wherein the one or more registers of the mailbox storage unit comprise a control register, a transport register, a write data register, a read data register, and a configuration register.

5. A system as claimed in claim 1, wherein the mailbox storage unit is configured to store communication control signals from the processor in one of the one or more registers.

6. A system as claimed in claim 5, wherein the interface state machine is configured to read control signals for a requested communication with the peripheral interface from the mailbox storage unit.

7. A system as claimed in claim 1, wherein the first data rate is greater than the second data rate.

8. A system as claimed in claim 1, further comprising an interrupt mechanism configured to transport a generated interrupt to the processor interrupt bus; and
wherein the peripheral interface unit further comprises an interrupt line connecting the peripheral interface unit to the interrupt mechanism.

9. A system as claimed in claim 8, wherein the interrupt mechanism is configured to. receive an interrupt signal from the peripheral component.

10. A method of interfacing a processor having a first bus with a peripheral component, wherein the processor includes a peripheral interface unit connected with a first bus of the processor and connectable with the peripheral component, and wherein the peripheral interface unit includes a mailbox storage unit, a peripheral interface connectable with the peripheral component, and an interface state machine connected between the first bus and the peripheral interface, comprising:
generating, by the interface state machine, a series of first data signals responsive to receipt by the peripheral interface unit of a communication from the processor;
generating, by the peripheral interface, a series of second data signals for communication to the peripheral component responsive to receipt of the series of data signals;
generating, by the peripheral interface, one or more second response signals for communication to the interface state machine, responsive to receipt by the peripheral interface of one or more first response signals from the peripheral component; and
generating, by the interface state machine, one or more third response signals for communication on the first bus using the mailbox storage unit responsive to receipt of the one or more second response signals from the peripheral interface unit.

11. A method as claimed in claim 10, wherein the second bus is an inter-integrated circuit bus and communication between the peripheral interface and the peripheral component is performed using an inter-integrated circuit communication protocol.

12. A method as claimed in claim 10, further comprising:
storing at least one of a series of first data signals received by the peripheral interface unit in one or more registers of the mailbox storage unit.

13. A method as claimed in claim 12, wherein at least one of the stored first data signals is a launch flag.

14. A method as claimed in claim 12, wherein the generating a series of second data signals is performed responsive to receipt of a launch flag signal.

15. A method as claimed in claim 10, further comprising:
generating an interrupt for communication to the processor indicative of receipt of one or more first response signals from the peripheral component.

16. A memory or a computer-readable medium storing instructions which, when executed by a processor, cause the processor to perform the method of claim 10.

17. A processor interface apparatus of a processor for interfacing the processor with a peripheral component, comprising:
processor bus interface means configured to communicate signals between the apparatus and the processor; and
peripheral component interface means configured to communicate signals between the apparatus and the peripheral component, wherein the peripheral component interface means stores a received processor-requested transaction with the peripheral component and communicates the transaction to the peripheral component responsive to receipt of a launch signal from the processor.

18. A processor interface apparatus as claimed in claim 17, the peripheral component interface means comprising:
mailbox storage means for storing one or more signals from the processor;
peripheral interface handling means for communicating with the peripheral component; and
interface state machine means for communicating between the peripheral interface handling means and the mailbox storage means.

19. A processor interface apparatus as claimed in claim 18, wherein the interface state machine means is configured to communicate control signals for a processor-requested transaction with the peripheral component from the mailbox storage means.

20. A processor interface apparatus as claimed in claim 17, wherein the peripheral component is an inter-integrated circuit bus-based component.
